(19) United States
(12) Patent Application Publication
(10) Pub. No.: US 2026/0133605 A1
(43) Pub. Date: May 14, 2026

(54) EXTERNAL BOX AND EXTERNAL DEVICE HAVING EXTERNAL BOX

(71) Applicant: ASUS GLOBAL PTE. LTD., Singapore (SG)

(72) Inventors: Fang-Ping YUAN, Singapore (SG); Qi HU, Singapore (SG); Xu WANG, Singapore (SG)

(21) Appl. No.: 19/049,417

(22) Filed: Feb. 10, 2025

(30) Foreign Application Priority Data
Nov. 8, 2024 (CN) 202411594978.5

(51) Int. Cl. G06F 1/16; G06F 1/18

(52) U.S. Cl. CPC G06F 1/1632; G06F 1/182; G06F 1/184; G06F 1/185; G06F 1/189

(57) ABSTRACT

The disclosure provides an external box and an external device having the external box. The external box is adapted to accommodate a graphics card and a mainboard, and adapted to connect to a computer device. The external box includes a shell and a circuit board. The circuit board is arranged at a bottom of the shell, and includes an external connector, a first connector, and a second connector. The external connector is arranged at an edge of the circuit board, and adapted to connect to the computer device. The first connector is arranged on an upper surface of the circuit board, and is electrically connected to the external connector. The first connector is adapted to install the graphics card. The second connector is arranged on the upper surface, and is electrically connected to the first connector. The second connector is adapted to install mainboard.

### CROSS-REFERENCE TO RELATED APPLICATION

This application claims the priority benefit of Chinese Application Serial No. 202411594978.5, filed on Nov. 8, 2024. The entirety of the above-mentioned patent application is hereby incorporated by reference herein and made a part of specification.

### BACKGROUND OF THE INVENTION

### Field of the Invention

The disclosure relates to an external box, and in particular, to an external box configured with a graphics card and an external device having the external box.

### Description of the Related Art

A notebook computer is limited by an internal space thereof, and it is often not possible to configure a high-performance graphics card to meet a requirement of a user. To resolve this problem, external graphics card devices have appeared on the market. A discrete graphics card is connected to a notebook computer through external connection, to improve display efficiency.

Currently, external graphics card devices on the market have a large footprint and are not used with a notebook computer or a computer chassis without a specific connection port, and therefore uses of the external graphics card devices are greatly limited.

### BRIEF SUMMARY OF THE INVENTION

The disclosure is intended to provide an external box and an external device having the external box, to resolve at least one of the foregoing problems.

The disclosure provides an external box. The external box is adapted for installing a graphics card and a mainboard, and is adapted for connecting to a computer device to operate. The external box includes a shell and a circuit board. The circuit board is arranged at a bottom of the shell, and includes an external connector, a first connector, and a second connector. The external connector is arranged at an edge of the circuit board, and adapted for connecting to the computer device. The first connector is arranged on an upper surface of the circuit board, and is electrically connected to the external connector. The first connector is adapted for installing the graphics card. The second connector is arranged on the circuit board, and is electrically connected to the first connector. The second connector is adapted for installing the mainboard.

The disclosure further provides an external device. The external device is adapted for connecting to a computer to operate. The external device includes a graphics card, a mainboard, and an external box. The external box includes a shell and a circuit board. The circuit board is arranged at a bottom of the shell, and includes an external connector, a first connector, and a second connector. The external connector is arranged at an edge of the circuit board, and adapted for connecting to the computer device. The first connector is arranged on an upper surface of the circuit board, and is electrically connected to the external connector. The first connector is adapted for installing the graphics card. The second connector is arranged on the circuit board, and is electrically connected to the first connector. The second connector is adapted for installing the mainboard.

The external box provided in the disclosure integrates the graphics card and the mainboard into a same external device. A user uses the external device as an external graphics card or an independent computer system based on an actual requirement, thereby effectively resolving a disadvantage that conventional external graphics card devices have a large footprint and are not used with a notebook computer or a computer chassis without a specific connection port.

### BRIEF DESCRIPTION OF THE DRAWINGS

FIG. 1 is a schematic diagram of an external box according to an embodiment of the disclosure;

FIG. 2 is a schematic top view of a circuit board in FIG. 1;

FIG. 3 is a schematic diagram of a functional block of a circuit board in FIG. 1;

FIG. 4 is a schematic diagram of an external box according to another embodiment of the disclosure; and

FIG. 5 is a schematic top view of a circuit board in FIG. 4.

### DETAILED DESCRIPTION OF THE EMBODIMENTS

Specific embodiments of the disclosure are described in more details below with reference to the schematic diagrams. Advantages and features of the disclosure are to be clearer based on the following descriptions and claims. It is to be noted that all of the accompanying drawings are in a very simple form and in an inaccurate proportion, and are merely intended to assist in illustrating the embodiments of the disclosure conveniently and clearly.

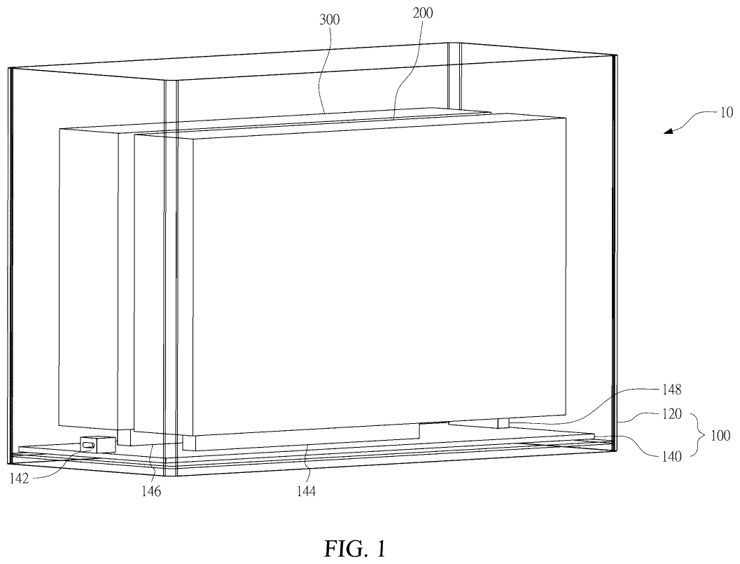

FIG. 1 is a schematic diagram of an external box 100 according to an embodiment of the disclosure. The external box 100 is adapted for connecting to a computer device (not shown), and operates with the computer device. In an embodiment, the computer device is a notebook computer or a computer chassis.

As shown in the figure, a graphics card 200 and a mainboard 300 are installed in the external box 100 of the disclosure, to form an external device 10. The graphics card 200 and the mainboard 300 in the figure are shown by dashed lines.

However, the disclosure is not limited thereto. Based on an actual use requirement, only one graphics card 200 or only one mainboard 300 may be installed in the external box 100.

The external box 100 of the disclosure is used with an existing graphics card 200 on the market as the external device 10. These graphics cards 200 each include a graphics card connector (not shown), such as a peripheral component interconnect express (PCI-E) connector, adapted for connecting to a mainboard on the market. The graphics card connector is usually a gold finger connector.

In addition, in an embodiment, the external box 100 of the disclosure is also used as the external device 10 with an existing mainboard 300 on the market, such as a small-size mainboard such as an information technology extended (ITX) mainboard or a mini-ITX mainboard. These mainboards 300 each include a mainboard connector (not shown), such as a PCI-E connector, adapted for installing another expansion card or connecting to another expansion board.

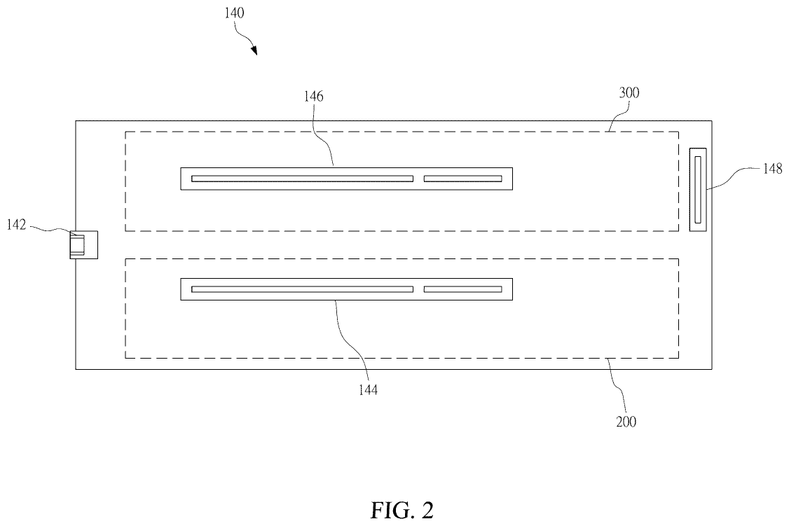

Referring to FIG. 2, FIG. 2 is a schematic top view of a circuit board 140 in FIG. 1. The graphics card 200 and the mainboard 300 arranged on the circuit board 140 are drawn with dashed lines. As shown in the figure, the external box 100 of the disclosure includes a shell 120 and a circuit board 140. The circuit board 140 is arranged at a bottom of the shell 120, and includes an external connector 142, a first connector 144, and a second connector 146.

The external connector 142 is arranged at an edge of the circuit board 140, and adapted for connecting to a computer device (not shown). In an embodiment, the external connector 142 is a thunderbolt connector. However, the disclosure is not limited thereto.

The first connector 144 is arranged on an upper surface of the circuit board 140, and is electrically connected to the external connector 142 through the circuit board 140. The graphics card 200 is adapted to connect to the first connector 144 through insertion. As shown in the figure, in this embodiment, the first connector 144 is a socket, and a corresponding connector on the graphics card 200 is a gold finger connector. However, the disclosure is not limited thereto. In addition, in an embodiment, the first connector 144 is a PCI-E connector.

The second connector 146 is arranged on the upper surface of the circuit board 140, and is electrically connected to the first connector 144 through the circuit board 140. The mainboard 300 is adapted to connect to the second connector 146 through insertion. As shown in the figure, in this embodiment, the second connector 146 is a socket, and a corresponding connector on the mainboard 300 is a gold finger connector. However, the disclosure is not limited thereto.

In addition, in an embodiment, a power module (not shown) is arranged in the external box 100. The power module is electrically coupled to a power connector 148 on the circuit board 140, to provide electric energy required for system operation.

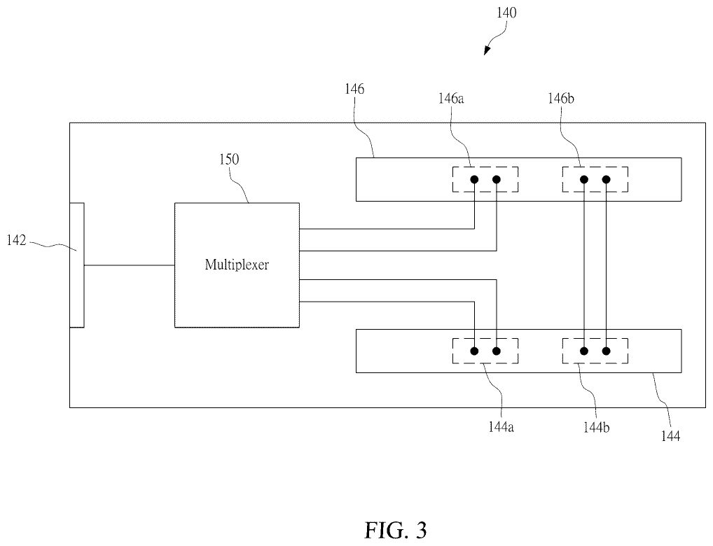

Referring to FIG. 3, FIG. 3 is a schematic diagram of a functional block of a circuit board 140 in FIG. 1.

As shown in the figure, to effectively utilize the functions of the graphics card 200 and the mainboard 300, a multiplexer 150 is arranged on the circuit board 140 in this embodiment. The multiplexer 150 is electrically connected to the external connector 142, the first connector 144, and the second connector 146, and adapted to selectively electrically connect the first connector 144 to the external connector 142 or the second connector 146.

In an embodiment, a transmission interface of the first connector 144 is the same as that of the second connector 146, and both the first connector and the second connector are PCI-E connectors. The transmission interface of the first connector 144 is different from that of the external connector 142, but supports the external connector 142. In an embodiment, when the first connector 144 is a PCI-E connector, the external connector 142 is a thunderbolt connector.

As shown in the figure, in a case that the first connector 144 and the second connector 146 are both PCI-E connectors, and the external connector 142 is a thunderbolt connector, the first connector 144 distinguishes between a first electrical contact group 144a and a second electrical contact group 144b (two contacts are drawn in the figure for illustration). Similarly, the second connector 146 also distinguishes between a third electrical contact group 146a and a fourth electrical contact group 146b (two contacts are drawn in the figure for illustration). The second electrical contact group 144b is electrically connected to the fourth electrical contact group 146b. The multiplexer 150 is adapted to selectively electrically connect the first electrical contact group 144a to the external connector 142 or the third electrical contact group 146a.

Further, when the first connector 144 and the second connector 146 are both PCI-E x16 connectors, and the external connector 142 is a thunderbolt connector, and supports a PCI-E x4 transmission specification, transmission contacts corresponding to a channel 4 to a channel 15 (all transmission channels are a channel 0 to a channel 15) in the first connector 144 are configured as a second electrical contact group 144b, and other contacts are configured as a first electrical contact group 144a. Similarly, transmission contacts corresponding to a channel 4 to a channel 15 (all transmission channels are a channel 0 to a channel 15) in the second connector 146 are configured as a fourth electrical contact group 146b, and other contacts are configured as a third electrical contact group 146a.

In this way, when a user needs to connect the external device 10 to a notebook computer or a computer chassis equipped with a thunderbolt connector for use, the multiplexer 150 electrically connects the first electrical contact group 144a to the external connector 142. In this case, the graphics card 200 operates based on the PCI-E x4 transmission specification.

In another aspect, when a user needs to use the external device 10 as an independent computer system, the multiplexer 150 electrically connects the first electrical contact group 144a to the third electrical contact group 146a, so that the graphics card 200 and the mainboard 300 in the external box 100 are connected based on a PCI-E x16 transmission specification.

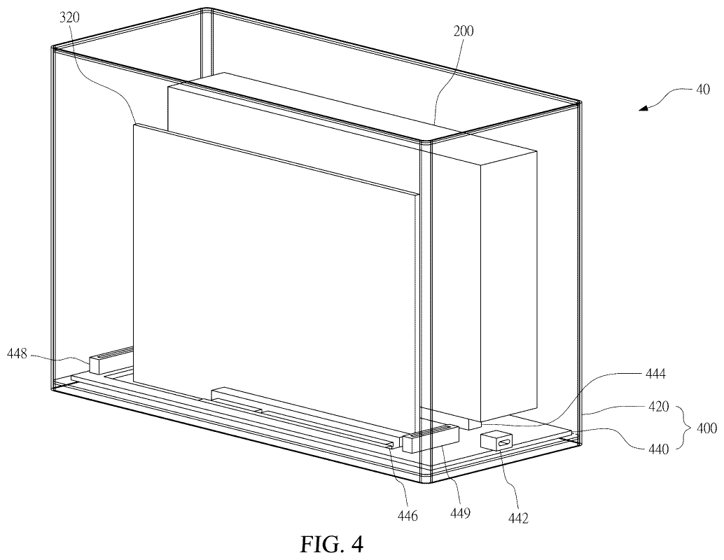

FIG. 4 is a schematic diagram of an external box 400 according to another embodiment of the disclosure.

As shown in the figure, a graphics card 200 and a mainboard 320 are installed in the external box 400 of the disclosure, to form an external device 40.

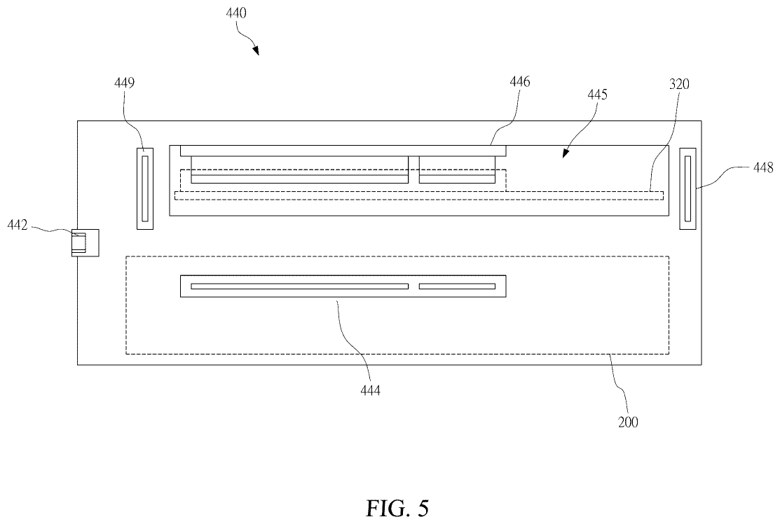

Referring to FIG. 5, FIG. 5 is a schematic top view of a circuit board 440 in FIG. 4. The graphics card 200 and the mainboard 320 arranged on the circuit board 440 are drawn with dashed lines. Compared with the embodiments in FIG. 1 and FIG. 2, the first connector 144 and the second connector 146 on the circuit board 140 are both sockets. A first connector 444 in this embodiment is maintained as a socket. However, a second connector 446 is a gold finger connector, to match the mainboard 320 configured with the socket 322 as a connector.

In addition, to match an arrangement position of the connector 322 on the mainboard 320, and ensure that the mainboard 320 is smoothly mounted in the external box 400 of the disclosure, the circuit board 440 of the external box 400 in this embodiment is provided with an opening 445 at a position corresponding to the second connector 446. The opening 445 is elongated and surrounds the second connector 446. The second connector 446 extends from a side of the opening 445 toward inside of the opening.

In this way, when the mainboard 320 needs to be installed to the external box, the opening 445 is used to accommodate a board edge of the mainboard 320, to facilitate insertion of the connector 322 of the mainboard into the second connector 446.

In addition, in an embodiment, as shown in the figure, an auxiliary power connector 449, such as a PCI-E connector system CEM5, is additionally arranged on the circuit board 440, to provide electric energy for the mainboard 320 or the graphics card 200.

Other elements of the external box 400 in this embodiment, such as a shell 420, an external connector 442, and a power connector 460, are similar to corresponding elements in the embodiments shown in FIG. 1 and FIG. 2. Details are not described herein.

Based on the above, the external box 100, 400 provided in the disclosure integrates the graphics card 200 and the mainboard 300, 320 into a same external device 10, 40. A user uses the external device 10, 40 as an external graphics card or an independent computer system based on an actual requirement, thereby effectively resolving a disadvantage that conventional external graphics card devices have a large footprint and are not used with a notebook computer or a computer chassis without a specific connection port.

Although the disclosure has been provided above through the embodiments, the embodiments are not intended to limit the disclosure. A person skilled in the art makes some changes and modifications without departing from the spirit and scope of the disclosure. Therefore, the protection scope of the disclosure is subject to that defined by the claims.

What is claimed is:

1. An external box, adapted for installing a graphics card and a mainboard, and adapted for connecting to a computer device to operate, wherein the external box comprises:
a shell; and
a circuit board, arranged at a bottom of the shell, and comprising:
an external connector, arranged at an edge of the circuit board, and adapted for connecting to the computer device;
a first connector, arranged on an upper surface of the circuit board and electrically connected to the external connector, wherein the first connector is adapted for installing the graphics card; and
a second connector, arranged on the circuit board and electrically connected to the first connector, wherein the second connector is adapted for installing the mainboard.

2. The external box according to claim 1, wherein the second connector is a socket.

3. The external box according to claim 1, wherein the second connector is a gold finger connector.

4. The external box according to claim 3, wherein the circuit board is provided with an opening, and the opening surrounds the second connector to accommodate the mainboard.

5. The external box according to claim 1, wherein the second connector is a socket.

6. The external box according to claim 1, wherein the first connector is a peripheral component interconnect express (PCI-E) connector.

7. The external box according to claim 1, wherein the second connector is a PCI-E connector.

8. The external box according to claim 1, wherein the external connector is a thunderbolt connector.

9. The external box according to claim 1, wherein a transmission interface of the first connector is the same as that of the second connector.

10. The external box according to claim 1, wherein a transmission interface of the first connector is different from that of the external connector, but supports the external connector.

11. The external box according to claim 1, further comprising a multiplexer, wherein the multiplexer is arranged on the circuit board, electrically connected to the external connector, the first connector, and the second connector, and adapted to selectively electrically connect the first connector to the external connector or the second connector.

12. The external box according to claim 11, wherein the first connector comprises a first electrical contact group and a second electrical contact group, and the second connector comprises a third electrical contact group and a fourth electrical contact group, wherein the second electrical contact group is electrically connected to the fourth electrical contact group, and the multiplexer is adapted to selectively electrically connect the first electrical contact group to the external connector or the third electrical contact group.

13. An external device, adapted for connecting to a computer device to operate, wherein the external device comprises:
a graphics card;
a mainboard; and
an external box, comprising:
a shell; and
a circuit board, arranged at a bottom of the shell, and comprising:
an external connector, arranged at an edge of the circuit board, and adapted for connecting to the computer device;
a first connector, arranged on an upper surface of the circuit board and electrically connected to the external connector, wherein the first connector is adapted for installing the graphics card; and
a second connector, arranged on the circuit board and electrically connected to the first connector, wherein the second connector is adapted for installing the mainboard.
